(19) United States
(12) Patent Application Publication
(10) Pub. No.: US 2025/0145754 A1
(43) Pub. Date: May 8, 2025

(54) HYDROCARBON BASED IONOMER FOR MEMBRANE-ELECTRODE ASSEMBLY WITH HIGH PROTON CONDUCTIVITY AND DURABILITY AND A MEMBRANE-ELECTRODE ASSEMBLY INCLUDING THE SAME

(71) Applicants: Hyundai Motor Company, Seoul (KR); Kia Corporation, Seoul (KR); Korea Advanced Institute of Science and Technology, Daejeon (KR)

(72) Inventors: Il Seok CHAE, Seoul (KR); Jong Kil OH, Yongin-si (KR); Myung Eun SEO, Daejeon (KR); Seon Woo YANG, Daejeon (KR)

(21) Appl. No.: 18/789,082

(22) Filed: Jul. 30, 2024

(30) Foreign Application Priority Data
Nov. 8, 2023 (KR) 10-2023-0153207

(51) Int. Cl. C08F 293/00; C08J 5/22; C25B 9/23; C25B 13/08; H01M 8/10; H01M 8/1004; H01M 8/1027; H01M 8/103; H01M 8/1032; H01M 8/1053

(52) U.S. Cl. CPC C08F 293/00; C08J 5/2287; C25B 9/23; C25B 13/08; H01M 8/1004; H01M 8/1027; H01M 8/103; H01M 8/1032; H01M 8/1053; C08J 2353/00; H01M 2008/1095

(57) ABSTRACT

A hydrocarbon-based ionomer for a membrane-electrode assembly includes a block copolymer. The block copolymer includes a triblock copolymer that is represented by A1ₙ₁-Bₘ-A2ₙ₂. A1 is a first hydrophobic domain, B is a hydrophilic domain, A2 is a second hydrophobic domain, n1 and n2 each is an integer greater than or equal to 100 and less than or equal to 4,000, and m is an integer greater than or equal to 100 and less than or equal to 8,000.

### CROSS-REFERENCE TO RELATED APPLICATION

This application claims priority to and the benefit of Korean Patent Application No. 10-2023-0153207 filed on Nov. 8, 2023, the disclosure of which is incorporated herein by reference in its entirety.

### TECHNICAL FIELD

The present disclosure relates to a hydrocarbon-based ionomer for a membrane-electrode assembly with high proton conductivity and durability, and a membrane-electrode assembly including the same.

### BACKGROUND

The proton exchange membrane (PEM), which is a core material used in various energy conversion and storage devices including fuel cells, can be used to selectively transfer only cations as an electrolyte and a separator. Therefore, the proton exchange membrane can require characteristics such as high proton conductivity, outstanding physicochemical stability, ease of mass production (scalable), and low production costs.

Currently, the most widely used proton exchange membranes include Nafion®, a perfluorinated electrolyte from DuPont, Gore-Select®, a perfluorinated porous-filled structure membrane from Gore, etc. These are widely used in commercial or commissioning fuel cells, oxidation/reduction flow cells, electrochemical hydrogen compressor systems, and the like due to their high proton conductivity and chemical stability.

However, existing perfluorinated proton exchange products present issues or concerns with the adoption of eco-friendly and highly efficient low-cost type energy conversion and storage systems due to a decomposition problem caused by oxygen radicals, an environmental pollution problem caused by hydrofluoric acid and contaminants during an incineration process, and high unit costs caused by complex manufacturing processes that use large amounts of fluorinated surfactants.

### SUMMARY

A hydrocarbon-based ionomer for a membrane-electrode assembly can include a block copolymer. The block copolymer can include one or more hydrophilic domains and one or more hydrophobic domains.

In some implementations, the one or more hydrophobic domains can include a first hydrophobic domain and a second hydrophobic domain. The block copolymer can include the first hydrophobic domain at a first end of the block copolymer and the second hydrophobic domain at a second end of the block copolymer.

In some implementations, the block copolymer can include a triblock copolymer that is represented by A1ₙ₁-Bₘ-A2ₙ₂. A1 is the first hydrophobic domain, B is a hydrophilic domain of the one or more hydrophilic domains, A2 is the second hydrophobic domain, each of n1 and n2 is an integer greater than or equal to 100 and less than or equal to 4,000, and m is an integer greater than or equal to 100 and less than or equal to 8,000.

In some implementations, the one or more hydrophilic domains can include a proton conductive repeating portion represented by Formula 1, in which the Formula 1 corresponds to:

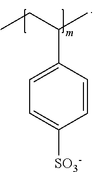

m is an integer that is greater than or equal to 100 and less than or equal to 8,000.

In some implementations, the one or more hydrophobic domains can include a hard segment and an antioxidative segment.

In some implementations, the hard segment can include at least one of repeating portions represented by Formula 2-1, Formula 2-2, and Formula 2-3. The Formula 2-1 corresponds to:

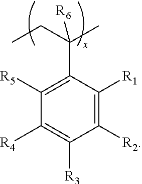

Each of R₁ to R₅ of the Formula 2-1 includes a hydrogen, an alkyl group having 1 to 12 carbon atoms, a tert-butyl group, a phenyl group,

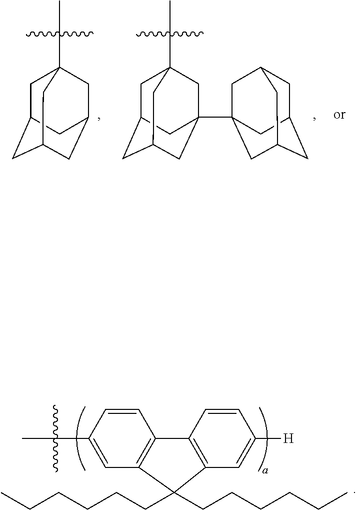

a corresponds to a number 1, 2, or 3. R₆ includes a hydrogen or an alkyl group having 1 to 12 carbon atoms, and x of the Formula 2-1 corresponds to a number greater than 0 and less than or equal to 0.9.

The Formula 2-2 corresponds to:

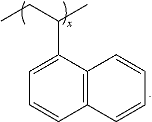

x of the Formula 2 corresponds to a number greater than 0 and less than or equal to 0.9.

The Formula 2-3 corresponds to:

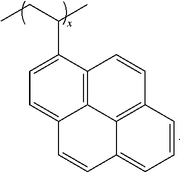

x of the Formula 2-3 corresponds to a number greater than 0 and less than or equal to 0.9.

In some implementations, the antioxidative segment can include one or more nitric oxide (NO) radicals.

In some implementations, the antioxidative segment can include at least one of repeating portions represented by Formula 3-1, Formula 3-2, Formula 3-3, and Formula 3-4.

The Formula 3-1 corresponds to:

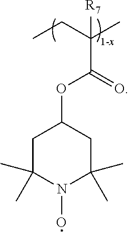

R₇ of the Formula 3-1 includes a hydrogen or an alkyl group that has 1 to 4 carbon atoms and x of the Formula 3-1 corresponds to a number that is greater than 0 and less than or equal to 0.9.

The Formula 3-2 corresponds to:

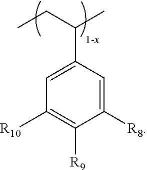

Each of R₈, R₉, and R₁₀ of the Formula 3-2 includes a hydrogen or

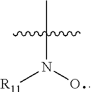

R₁₁ of the Formula 3-2 comprises a tert-butyl group or

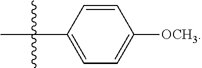 [SMILES: *c1ccc(OC)cc1]

x of the Formula 3-2 corresponds to a number that is greater than 0 and less than or equal to 0.9.

The Formula 3-3 corresponds to:

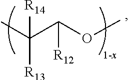

Each of R₁₂ and R₁₃ of the Formula 3-3 includes

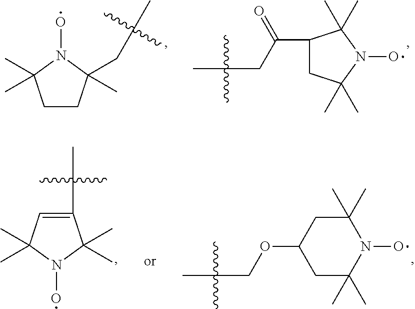

R₁₄ of the Formula 3-3 includes a hydrogen or an alkyl group having 1 to 4 carbon atoms and x of the Formula 3-3 corresponds to a number that is greater than 0 and less than or equal to 0.9.

The Formula 3-4 corresponds to:

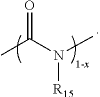

R₁₅ of the Formula 3-4 includes

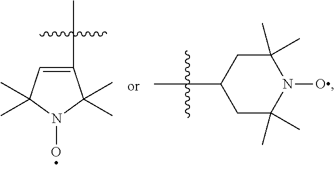

and x of the Formula 3-4 corresponds to a number that is greater than 0 and less than or equal to 0.9.

In some implementations, the block copolymer can have a weight average molecular weight M_{w} that is greater than or equal to 60,000 g/mol and less than or equal to 200,000 g/mol.

A membrane-electrode assembly can include an electrolyte membrane, a first electrode disposed on a first surface of the electrolyte membrane and a second electrode disposed on a second surface of the electrolyte membrane. For example, at least one of the electrolyte membrane, the first electrode and the second electrode can include a hydrocarbon-based ionomer. For example, the hydrocarbon-based ionomer can include a block copolymer that comprises a hydrophilic domain and a hydrophobic domain.

In some implementations, the electrolyte membrane includes a reinforcement layer which can be impregnated with the hydrocarbon-based ionomer.

In some implementations, the reinforcement layer includes an expanded polytetrafluoroethylene (e-PTFE).

A fuel cell can include a membrane-electrode assembly. The membrane-electrode assembly can include an electrolyte membrane, a first electrode disposed on a first surface of the electrolyte membrane and a second electrode disposed on a second surface of the electrolyte membrane For example, at least one of the electrolyte membrane, the first electrode and the second electrode can include a hydrocarbon-based ionomer. For example, the hydrocarbon-based ionomer can include a block copolymer that comprises a hydrophilic domain and a hydrophobic domain.

A water electrolysis device can include a membrane-electrode assembly. The membrane-electrode assembly includes an electrolyte membrane, a first electrode disposed on a first surface of the electrolyte membrane and a second electrode disposed on a second surface of the electrolyte membrane. For example, at least one of the electrolyte membrane, the first electrode and the second electrode includes a hydrocarbon-based ionomer. For example, the hydrocarbon-based ionomer can include a block copolymer that includes one or more hydrophilic domains and one or more hydrophobic domains.

In some implementations, the one or more hydrophobic domains can include a first hydrophobic domain and a second hydrophobic domain. The block copolymer can include the first hydrophobic domain at a first end of the block copolymer and the second hydrophobic domain at a second end of the block copolymer.

In some implementations, the block copolymer can include a triblock copolymer that is represented by A1ₙ₁-Bₘ-A2ₙ₂. A1 is the first hydrophobic domain, B is a hydrophilic domain of the one or more hydrophilic domains, A2 is the second hydrophobic domain, each of n1 and n2 is an integer greater than or equal to 100 and less than or equal to 4,000, and m is an integer greater than or equal to 100 and less than or equal to 8,000.

In some implementations, the one or more hydrophilic domains can include a proton conductive repeating portion represented by Formula 1, in which the Formula 1 corresponds to:

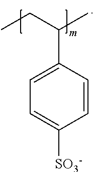

m is an integer that is greater than or equal to 100 and less than or equal to 8,000.

In some implementations, the one or more hydrophobic domains can include a hard segment and an antioxidative segment.

In some implementations, the hard segment can include at least one of repeating portions represented by Formula 2-1, Formula 2-2, and Formula 2-3. The Formula 2-1 corresponds to:

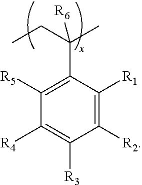

Each of R₁ to R₅ of the Formula 2-1 includes a hydrogen, an alkyl group having 1 to 12 carbon atoms, a tert-butyl group, a phenyl group,

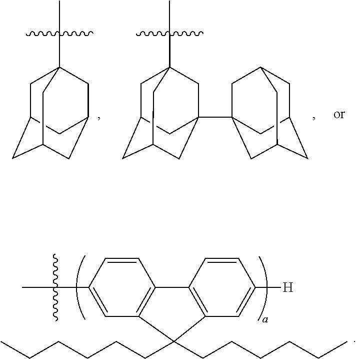

a corresponds to a number 1, 2, or 3. R₆ includes a hydrogen or an alkyl group having 1 to 12 carbon atoms, and x of the Formula 2-1 corresponds to a number greater than 0 and less than or equal to 0.9.

The Formula 2-2 corresponds to:

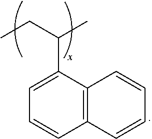

x of the Formula 2 corresponds to a number greater than 0 and less than or equal to 0.9.

The Formula 2-3 corresponds to:

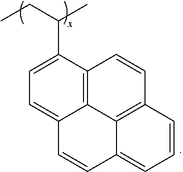

x of the Formula 2-3 corresponds to a number greater than 0 and less than or equal to 0.9.

In some implementations, the antioxidative segment can include one or more nitric oxide (NO) radicals.

### BRIEF DESCRIPTION OF THE DRAWINGS

FIG. 1 illustrates a diagram of an example of a membrane-electrode assembly.

FIG. 2 illustrates a diagram of an example of an electrolyte membrane.

FIG. 3 illustrates a diagram of an example of a hydrocarbon-based ionomer.

FIG. 4 illustrates a diagram of an example of an electrolyte membrane prior to heat treatment.

FIG. 5 illustrates an electrolyte membrane after heat treatment.

FIG. 6 illustrates results of an example of an analysis of the electrolyte membrane before and after performing heat treatment by Fourier transform infrared spectroscopy (FT-IR).

FIG. 7 illustrates results of an example of an evaluation of the antioxidative properties of the electrolyte membranes of Example and Comparative Example 1.

### DETAILED DESCRIPTION

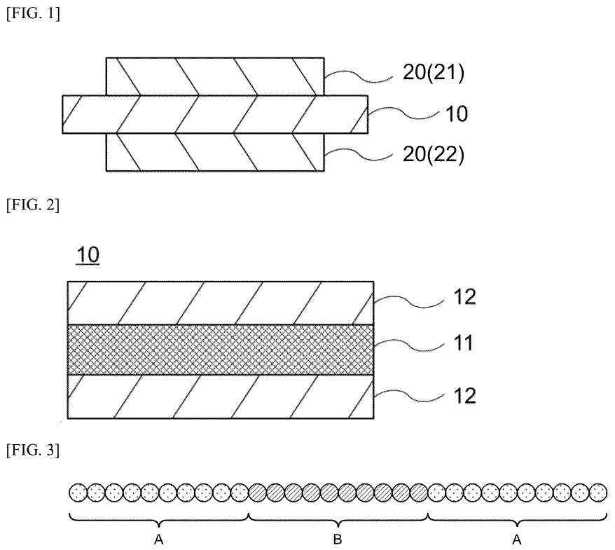

FIG. 1 illustrates a diagram of an example of a membrane-electrode assembly. The membrane-electrode assembly can be used in energy conversion devices such as fuel cells and water electrolysis devices. However, the use of the membrane-electrode assembly is not limited thereto, and it can be used for any feasible device or equipment.

The membrane-electrode assembly can include an electrolyte membrane 10 and a pair of electrodes 20 disposed on both surfaces of the electrolyte membrane 10. The pair of electrodes 20 may include a first electrode 21 disposed on a first surface of the electrolyte membrane 10, and a second electrode 22 disposed on a second surface of the electrolyte membrane 10. If the first electrode is a cathode, the second electrode may be an anode. And if the second electrode is a cathode, the first electrode may be an anode. At least one of the electrolyte membrane 10, the first electrode 21 and the second electrode 22 can include a hydrocarbon-based ionomer.

FIG. 2 illustrates a diagram of an example of an electrolyte membrane. The electrolyte membrane 10 can include a reinforcement layer 11 and an ion conductive layer 12 disposed on at least one surface of the reinforcement layer 11. The hydrocarbon-based ionomer can be impregnated in the reinforcement layer 11. Additionally, the hydrocarbon-based ionomer can constitute the ion conductive layer 12.

The reinforcement layer 11 can increase the durability of the electrolyte membrane 10, and its material is not particularly limited. For example, the reinforcement layer 11 can include expanded polytetrafluoroethylene (e-PTFE).

The reinforcement layer 11 can be a porous thin film that can be impregnated with the hydrocarbon-based ionomer. The thickness of the reinforcement layer 11 is not particularly limited and can be, for example, greater than or equal to 1 μm and less than or equal to 100 μm (e.g., range of 1 μm-100 μm).

The ion conductive layer 12 can further include a perfluorosulfonic acid-based polymer in addition to the hydrocarbon-based ionomer. The perfluorosulfonic acid-based polymer can include Nafion. Alternatively, the ion conductive layer 12 can be composed only of the hydrocarbon-based ionomer.

FIG. 3 illustrates a diagram of an example of a hydrocarbon-based ionomer. The hydrocarbon-based ionomer can include a block copolymer including one or more hydrophilic domains (B) and one or more hydrophobic domains (A).

The block copolymer can include hydrophobic domains (A) at both ends. When the hydrophilic domain (B) is present at the end of the block copolymer, polymer entanglement can occur due to a charge of the proton conductive group of the hydrophilic domain (B) and the block copolymer can become vulnerable to moisture. On the other hand, based on the block copolymer having the hydrophobic domain (A) at both ends, the block copolymer can have structural robustness and can prevent a polymer entanglement problem from occurring.

The block copolymer can include a triblock copolymer represented by A1ₙ₁-Bₘ-A2ₙ₂. A1 and A2 can be a first hydrophobic domain and a second hydrophobic domain, respectively, and can be the same as or different from each other. B can be a hydrophilic domain. n1 and n2 can be independently integers of 1 to 100, and can be the same as or different from each other. m can be an integer of 200 to 20,000.

The hydrophilic domain (B) can include a proton conductive repeating unit (or a proton conductive repeating portion). The proton conductive repeating unit can include a functional group such as a sulfonic acid group capable of transferring hydrogen ions.

The block copolymer can be self-assembled by the hydrophilic domain (B) to form a conduction channel for hydrogen ions. Conventional hydrocarbon-based ionomers can provide sulfonic acid groups by direct sulfonation of engineering plastics for the purpose of achieving proton conductivity. In the electrolyte membrane including a conventional hydrocarbon-based ionomer, dehydration phenomenon can worsen under high temperature and low humidification conditions, and the hydrogen ion conduction channel formed by water can collapse. On the other hand, since the hydrocarbon-based ionomer can self-assemble to form a hydrogen ion conduction channel, the hydrogen ion conduction channel can be maintained regardless of humidification conditions.

The hydrophobic domain (A) can include a hard segment that provides physical robustness to the block copolymer and an antioxidative segment that can remove active radicals.

Conventionally, antioxidants such as a cerium salt and cerium oxide were input to increase the durability of the electrolyte membrane. When a cerium salt in the form of ions is used as an antioxidant, issues arise due to trivalent or tetravalent cerium cations care being substituted in place of the hydrogen ions of the proton conductive functional group, resulting in lowered proton conductivity. When cerium oxide in a compound form is used as an antioxidant, issues arise due to particle size of the cerium oxide being greater than the hydration channel. Ultimately, there are issues in that the proton conductivity is greatly reduced due to a small amount of antioxidant. On the other hand, the hydrocarbon-based ionomer can enhance the chemical durability of the electrolyte membrane by collecting active radicals by the antioxidative segment while enhancing the robustness of the block copolymer by the hard segment. Meanwhile, since the antioxidative segment and the hydrophilic domain (B) are separated from each other within the polymer structure, they may not affect each other. Additionally, since the hydrophobic domain (A) and the hydrophilic domain (B) are covalently bonded in the block copolymer, there may not be a problem of either one being eluted.

The hydrophilic domain (B) can include a proton conductive repeating unit represented by Formula 1 below.

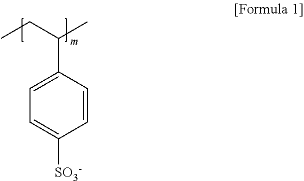

In Formula 1, m can be an integer of 100 to 8,000.

The hard segment of the hydrophobic domain (A) can include at least one of the repeating units represented by Formula 2-1 to Formula 2-3 below.

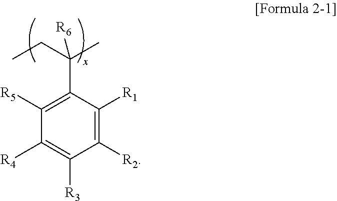

In Formula 2-1, R₁ to R₅ can each independently include hydrogen, an alkyl group having 1 to 12 carbon atoms, a tert-butyl group, a phenyl group,

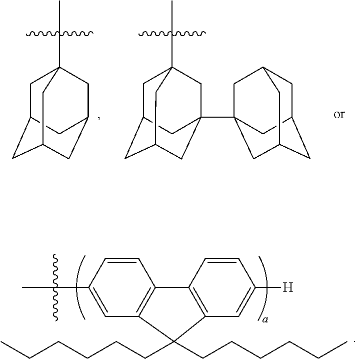

a can be 1, 2, or 3, R₆ can include hydrogen or an alkyl group having 1 to 12 carbon atoms, and x can be greater than 0 and less or equal to than 0.9.

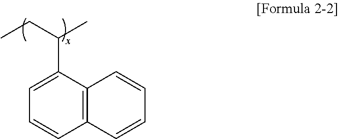

In Formula 2-2, x can be greater than 0 and less than or equal to 0.9.

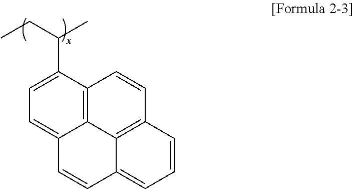

In Formula 2-3, x can be greater than 0 and less than or equal to 0.9.

The antioxidative segment of the hydrophobic domain (A) can include one or more nitric oxide (NO) radicals. Specifically, the antioxidative segment can include at least one of the repeating units represented by Formula 3-1 to Formula 3-4 below.

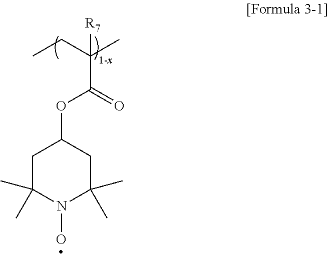

In Formula 3-1, R₇ can include hydrogen or an alkyl group having 1 to 4 carbon atoms, and x can be greater than 0 and less than or equal to 0.9.

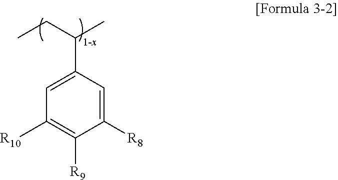

In Formula 3-2, R₈, R₉, and R₁₀ can each independently include hydrogen or

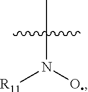

R₁₁ can include a tert-butyl group or

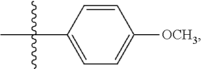 [SMILES: *c1ccc(OC)cc1]

and x can be greater than 0 and less than or equal to 0.9.

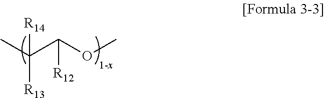

In Formula 3-3, R₁₂ and R₁₃ can each independently include

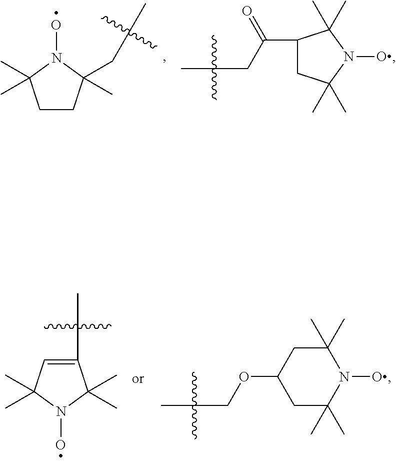

R₁₄ can include hydrogen or an alkyl group having 1 to 4 carbon atoms, and x can be greater than 0 and less than or equal to 0.9

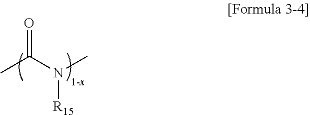

In Formula 3-4, R₁₅ can include

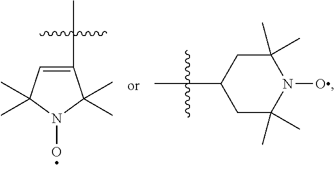

and x can be greater than 0 and less than or equal to 0.9.

For example, the block copolymer can be represented by Formula 4 below.

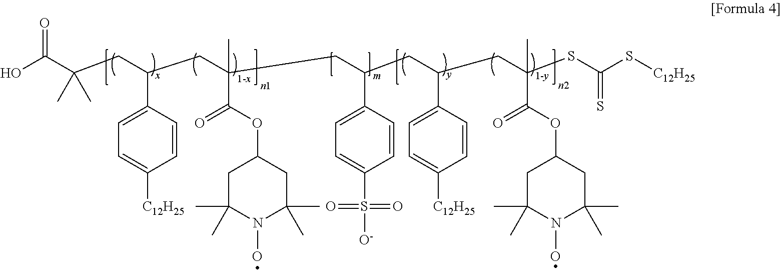

In Formula 4, n1 and n2 can be independently integers of 100 to 4,000, m can be an integer of 100 to 8,000, and x and y can independently be numbers of more than 0 and equal to or less than 0.9. When x and y fall within the above numerical range, the block copolymer can exhibit antioxidative properties by collecting radicals at the same time while forming a conduction channel for hydrogen ions.

The Formula 4 is a state in which the block copolymer is in hydrated state. The block copolymer in unhydrated state can be represented by Formula 5 below.

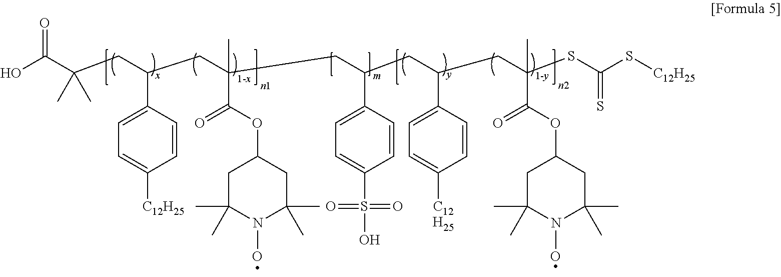

In Formula 5, n1, n2, m, x, and y are the same as those described in Formula 4. Although the weight average molecular weight M_{w} of the block copolymer is not particularly limited, it can be, for example, from 60,000 g/mol to 200,000 g/mol.

The method for preparing the block copolymer is not particularly limited, and it can be obtained by reacting the precursors of the hydrophobic domain (A) and the hydrophilic domain (B) under appropriate conditions. This will be explained specifically in the Preparation Example below.

### Preparation Example

4-dodecylstyrene (1 in Reaction Formula 1) was prepared as a precursor of a hard segment. 2,2,6,6-Tetramethyl-4-piperidyl methacrylate (2 in Reaction Formula 1) was prepared as a precursor of an antioxidative segment.

1 equivalent of 2-(Dodecylthiocarbonothioylthio)-2-methylpropionic acid (DDMAT), 190 equivalents of a precursor of the hard segment, and 10 equivalents of a precursor of the antioxidative segment were put into an ampoule along with toluene, and the freeze-pump-thaw cycle was repeated three times. The resulting product was polymerized at about 120° C. for about 12 hours to obtain a first intermediate represented by 3 in Reaction Formula 1 below.

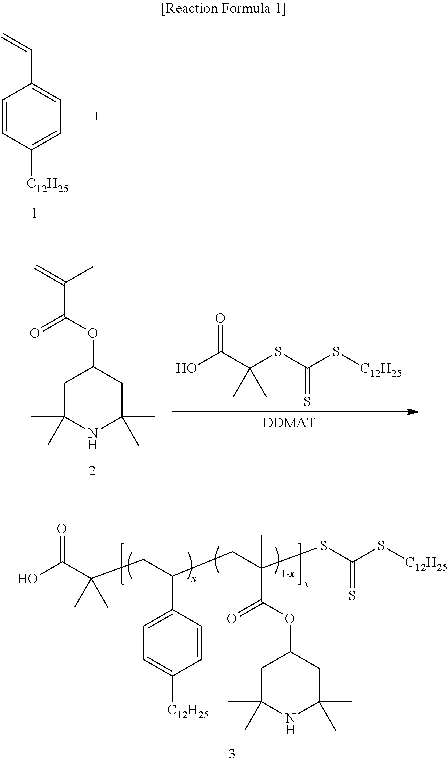

Neopentyl p-styrenesulfonate (4 in Reaction Formula 2) was prepared as a precursor of the hydrophilic domain. The precursor of the hydrophilic domain is not limited thereto, and p-styrenesulfonate containing a propyl group, isopropyl group, butyl group, isobutyl group, pentyl group, etc. can also be used.

One equivalent of the first intermediate and 200 equivalents of the precursor of the hydrophilic domain were put into an ampoule along with toluene, and the freeze-pump-thaw cycle was repeated three times. The resulting product was polymerized at about 70° C. for about 12 hours using azobisisobutyronitrile (AIBN) as a radical initiator to obtain a second intermediate represented by 5 in Reaction Formula 2 below.

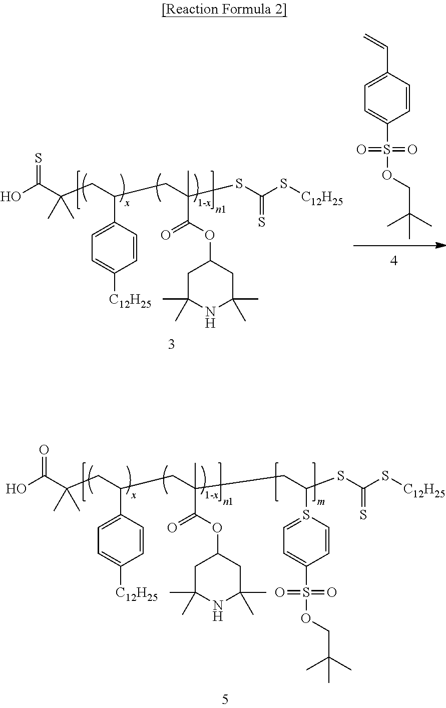

1 equivalent of the second intermediate, 190 equivalents of the precursor of the hard segment, and 10 equivalents of the precursor of the antioxidative segment were put into an ampoule along with toluene, and the freeze-pump-thaw cycle was repeated three times. The resulting product was polymerized at about 70° C. for about 12 hours using azobisisobutyronitrile (AIBN) as a radical initiator to obtain a third intermediate that is represented by 6 in Reaction Formula 3 below.

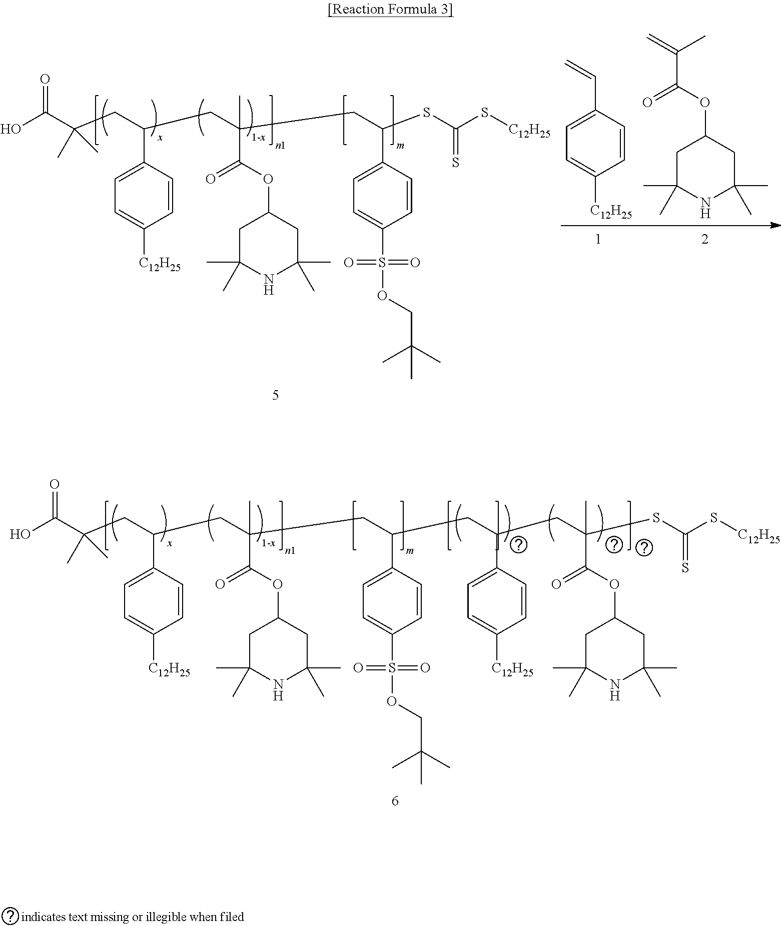

Approximately 2 g of the third intermediate was dispersed in about 50 g of dichloromethane, and then about 8 g of meta-Chloroperoxybenzoic acid (mCPBA) was input into the dispersion. After about 8 hours had passed, the resulting product was filtered to obtain a fourth intermediate represented by 7 in Reaction Formula 4 below.

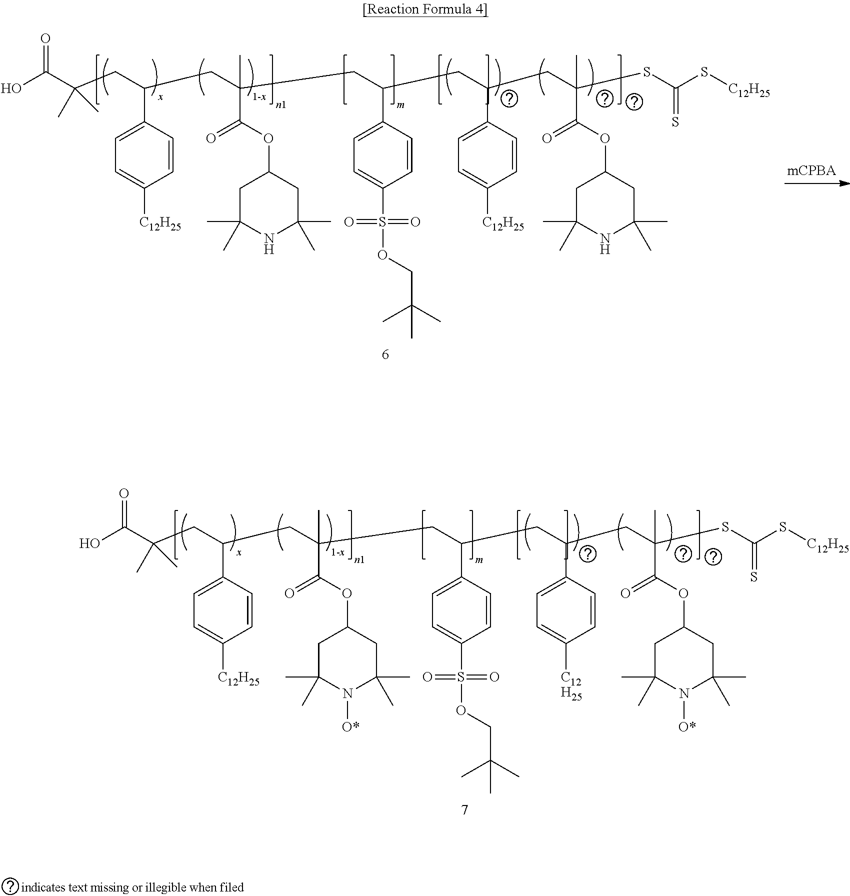

Sulfonate ester containing a neo-pentyl group in the hydrophilic domain of the fourth intermediate can be converted to a sulfonic acid group (—SO₃H) through heat treatment in an Example to be described later.

### Comparative Preparation Example

In carrying out Reaction Formula 1 and Reaction Formula 3 above, the fourth intermediate was prepared in the same manner as in the Preparation Example except that 200 equivalents of the precursor of the hard segment were used without using the precursor of the antioxidative segment.

### EXAMPLE

An electrolyte membrane was prepared as follows using the fourth intermediate according to the above Preparation Example.

A solution in which about 2 g of the fourth intermediate according to the above Preparation Example was dissolved in a mixed solvent of about 8 mL of toluene and tetrahydrofuran was prepared. Expanded polytetrafluoroethylene (e-PTFE), which was the reinforcement layer, was impregnated with the solution for a predetermined time, taken out, and dried. The dried resulting product was heat-treated at about 160° C. for about 2 hours to convert sulfonate ester of the fourth intermediate into a sulfonic acid group, which is a proton conductive functional group.

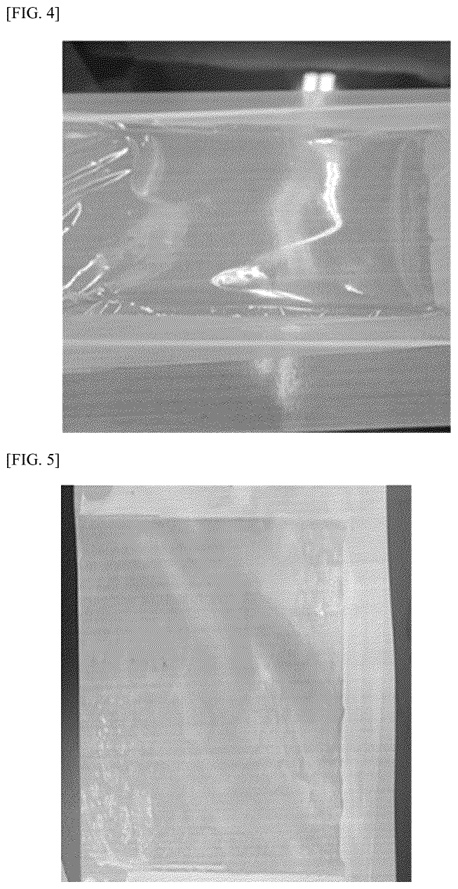

FIG. 4 illustrates a diagram of an example of an electrolyte membrane prior to heat treatment. FIG. 5 illustrates an electrolyte membrane after the heat treatment.

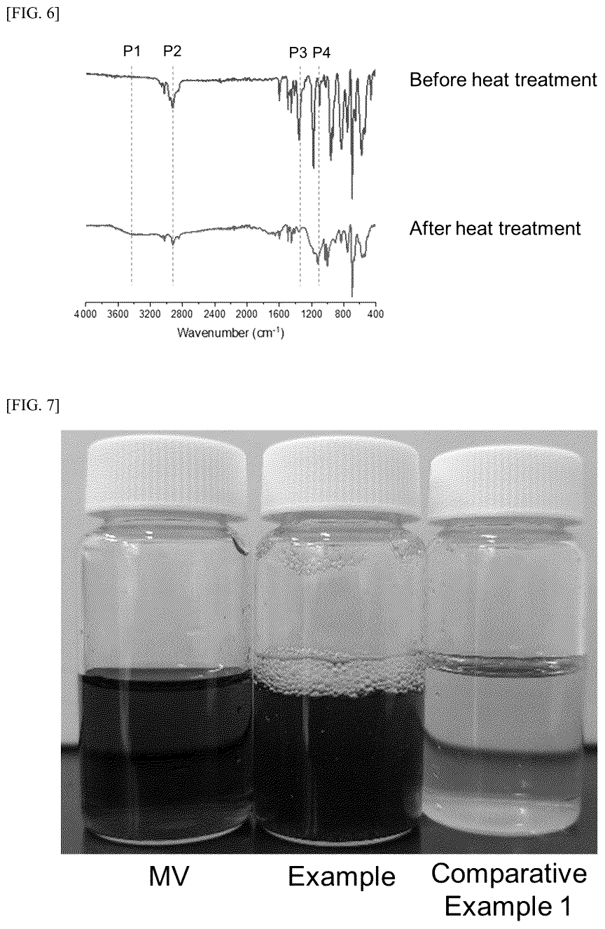

FIG. 6 illustrates results of an example of an analysis of the electrolyte membrane before and after performing heat treatment by Fourier transform infrared spectroscopy (FT-IR). The first peak (P1) found at a wavelength of about 3,500 cm⁻¹ and the fourth peak (P4) found at a wavelength of about 1,120 cm⁻¹ are due to sulfonic acid. The second peak (P2) found at a wavelength of about 2,950 cm⁻¹ is due to sp3 C—H bonds. The third peak (P3) found at a wavelength of about 1,350 cm⁻¹ is due to sulfonate ester. It can be seen that sulfonate ester of the fourth intermediate can be well converted to a sulfonic acid group through the heat treatment based on an observation that first peak (P1) and the fourth peak (P4) increase, and the second peak (P2) and the third peak (P3) decrease.

### Comparative Example 1

An electrolyte membrane was prepared in the same manner as in the Example using the fourth intermediate according to the Comparative Preparation Example.

### Experimental Example 1

The proton conductivities of the electrolyte membranes according to the Example and the Comparative Example 1 were measured. The proton conductivity of each electrolyte membrane was measured in an in-plane direction at about 80° C. while varying the relative humidity. The results are shown in Table 1 below. Comparative Example 2 is a commercially available Nafion 211 electrolyte membrane.

TABLE 1

| | Proton conductivity [mS/cm] | | |
|---|---|---|---|
| Relative | | Comparative | Comparative |
| humidity [%] | Example | Example 1 | Example 2 |
| 20 | 9.21 | 9.21 | 7.32 |
| 30 | 17.42 | 17.42 | 16.51 |
| 40 | 33.92 | 33.92 | 29.49 |
| 50 | 51.93 | 51.93 | 46.29 |
| 60 | 77.14 | 88.24 | 69.95 |
| 70 | 116.81 | 153.32 | 95.81 |
| 80 | 170.35 | 264.91 | 123.60 |
| 90 | 645.55 | 645.55 | 198.26 |
| 95 | 1978.31 | 1978.31 | 286.96 |

The electrolyte membrane according to the Example shows high proton conductivity even at low relative humidity, and shows high proton conductivity compared to Comparative Example 2 under all relative humidity conditions. Additionally, referring to the results of Example and Comparative Example 1, it can be seen that whether the antioxidative segment is present or not has an insignificant effect on proton conductivity.

### Experimental Example 2

The antioxidative properties of the electrolyte membranes according to Example and Comparative Example 1 were measured by colorimetry using methyl violet. The methyl violet has characteristics of changing from purple to colorless when it reacts with hydroxyl radicals. The better the antioxidative properties of the test subject, the longer the methyl violet maintains purple color. On the other hand, if the test subject does not have antioxidative properties, methyl violet changes to a transparent color within few seconds.

The electrolyte membranes according to Example and Comparative Example 1 were each input into about 9 g of methyl violet in an amount of 0.01 g, and a Fenton solution was put thereinto. The results are as shown in FIG. 7. Based on the fact that the methyl violet pf the Example maintained purple color, whereas the methyl violet of the Comparative Example 1 became transparent, it can be seen that the hydrocarbon-based ionomer possesses antioxidative properties due to the hydrophobic domain.

The scope of the present disclosure is not limited to the above-described Experimental Examples and the Example, and various modifications and improved forms can also be included in the scope of the present disclosure.

What is claimed is:

1. A hydrocarbon-based ionomer for a membrane-electrode assembly, the hydrocarbon-based ionomer comprising:
a block copolymer comprising one or more hydrophilic domains and one or more hydrophobic domains.

2. The hydrocarbon-based ionomer of claim 1, wherein the one or more hydrophobic domains comprise a first hydrophobic domain and a second hydrophobic domain,
wherein the block copolymer comprises the first hydrophobic domain at a first end of the block copolymer and the second hydrophobic domain at a second end of the block copolymer.

3. The hydrocarbon-based ionomer of claim 1, wherein the one or more hydrophobic domains comprise a first hydrophobic domain and a second hydrophobic domain,
wherein the one or more hydrophilic domains comprise a hydrophilic domain,
wherein the block copolymer comprises a triblock copolymer that is represented by A1ₙ₁-Bₘ-A2ₙ₂, and
wherein A1 is the first hydrophobic domain, B is the hydrophilic domain, A2 is the second hydrophobic domain, each of n1 and n2 is an integer greater than or equal to 100 and less than or equal to 4,000, and m is an integer greater than or equal to 100 and less than or equal to 8,000.

4. The hydrocarbon-based ionomer of claim 1, wherein the one or more hydrophilic domains comprise a proton conductive repeating portion represented by Formula 1,
wherein the Formula 1 corresponds to: 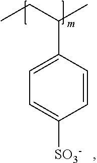
and
wherein m is an integer that is greater than or equal to 100 and less than or equal to 8,000.

5. The hydrocarbon-based ionomer of claim 1, wherein the one or more hydrophobic domains comprise a hard segment and an antioxidative segment.

6. The hydrocarbon-based ionomer of claim 5, wherein the hard segment comprises at least one of repeating portions represented by Formula 2-1, Formula 2-2, and Formula 2-3,
wherein Formula 2-1 corresponds to: 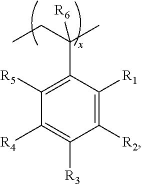
wherein each of R₁ to R₅ of the Formula 2-1 comprises a hydrogen, an alkyl group having 1 to 12 carbon atoms, a tert-butyl group, a phenyl group, 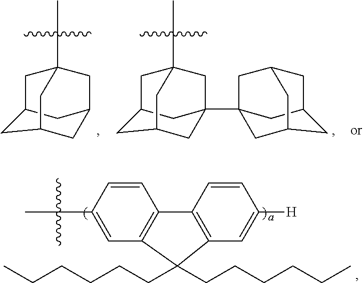
wherein a corresponds to 1, 2, or 3, R₆ comprises hydrogen or an alkyl group having 1 to 12 carbon atoms, and x of the Formula 2-1 corresponds to a number greater than 0 and less than or equal to 0.9,
wherein the Formula 2-2 corresponds to: 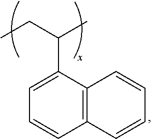
wherein x of the Formula 2 corresponds to a number greater than 0 and less than or equal to 0.9,
wherein the Formula 2-3 corresponds to: 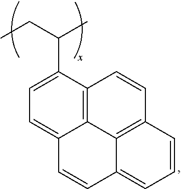
and
wherein x of the Formula 2-3 corresponds to a number greater than 0 and less than or equal to 0.9.

7. The hydrocarbon-based ionomer of claim 5, wherein the antioxidative segment comprises one or more nitric oxide (NO) radicals.

8. The hydrocarbon-based ionomer of claim 5, wherein the antioxidative segment comprises at least one of repeating portions represented by Formula 3-1, Formula 3-2, Formula 3-3, and Formula 3-4,
wherein the Formula 3-1 corresponds to: 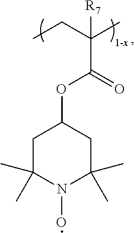
wherein R₇ of the Formula 3-1 comprises a hydrogen or an alkyl group that has 1 to 4 carbon atoms,
wherein x of the Formula 3-1 corresponds to a number that is greater than 0 and less than or equal to 0.9,
wherein Formula 3-2 corresponds to: 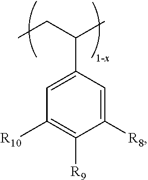
wherein each of R₈, R₉, and R₁₀ of the Formula 3-2 comprises a hydrogen or 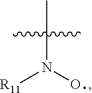
R₁₁ of the Formula 3-2 comprises a tert-butyl group or 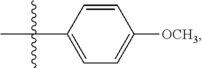 [SMILES: *c1ccc(OC)cc1]
and x of the Formula 3-2 corresponds to a number that is greater than 0 and less than or equal to 0.9,
wherein Formula 3-3 corresponds to: 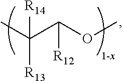
wherein each of R₁₂ and R₁₃ of the Formula 3-3 comprises 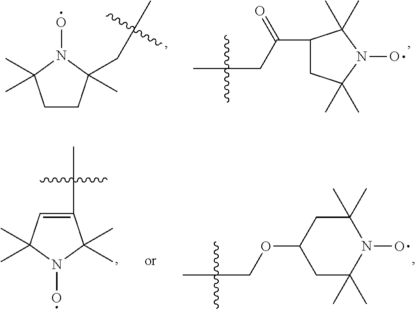
R₁₄ of the Formula 3-3 comprises a hydrogen or an alkyl group having 1 to 4 carbon atoms, and x of the Formula 3-3 corresponds to a number that is greater than 0 and less than or equal to 0.9,
wherein the Formula 3-4 corresponds to: 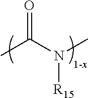
wherein R₁₅ of the Formula 3-4 comprises 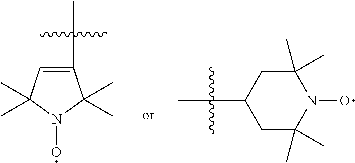
and x of the Formula 3-4 corresponds to a number that is greater than 0 and less than or equal to 0.9.

9. The hydrocarbon-based ionomer of claim 1, wherein the block copolymer has a weight average molecular weight M_{w} that is greater than or equal to 60,000 g/mol and less than or equal to 200,000 g/mol.

10. A membrane-electrode assembly comprising:
an electrolyte membrane;
a first electrode disposed on a first surface of the electrolyte membrane; and
a second electrode disposed on a second surface of the electrolyte membrane,
wherein at least one of the electrolyte membrane, the first electrode and the second electrode comprises a hydrocarbon-based ionomer, and
wherein the hydrocarbon-based ionomer comprises:
a block copolymer that comprises one or more hydrophilic domains and one or more hydrophobic domains.

11. The membrane-electrode assembly of claim 10, wherein the electrolyte membrane comprises a reinforcement layer, and
wherein the reinforcement layer is impregnated with the hydrocarbon-based ionomer.

12. The membrane-electrode assembly of claim 11, wherein the reinforcement layer comprises an expanded polytetrafluoroethylene (e-PTFE).

13. A fuel cell comprising:
a membrane-electrode assembly that comprises:
an electrolyte membrane;
a first electrode disposed on a first surface of the electrolyte membrane; and
a second electrode disposed on a second surface of the electrolyte membrane,
wherein at least one of the electrolyte membrane, the first electrode and the second electrode comprises a hydrocarbon-based ionomer, and
wherein the hydrocarbon-based ionomer comprises:
a block copolymer that comprises one or more hydrophilic domains and one or more hydrophobic domains.

14. A water electrolysis device comprising:
a membrane-electrode assembly that comprises:
an electrolyte membrane;
a first electrode disposed on a first surface of the electrolyte membrane; and
a second electrode disposed on a second surface of the electrolyte membrane,
wherein at least one of the electrolyte membrane, the first electrode and the second electrode comprises a hydrocarbon-based ionomer, and
wherein the hydrocarbon-based ionomer comprises:
a block copolymer that comprises one or more hydrophilic domains and one or more hydrophobic domains.

15. The water electrolysis device of claim 14, wherein the one or more hydrophobic domains comprise a first hydrophobic domain and a second hydrophobic domain,
wherein the block copolymer comprises the first hydrophobic domain at a first end of the block copolymer and the second hydrophobic domain at a second end of the block copolymer.

16. The water electrolysis device of claim 14, wherein the one or more hydrophobic domains comprise a first hydrophobic domain and a second hydrophobic domain,
wherein the one or more hydrophilic domains comprise a hydrophilic domain,
wherein the block copolymer comprises a triblock copolymer that is represented by A1ₙ₁-Bₘ-A2ₙ₂, and
wherein A1 is the first hydrophobic domain, B is the hydrophilic domain, A2 is the second hydrophobic domain, each of n1 and n2 is an integer greater than or equal to 100 and less than or equal to 4,000, and m is an integer greater than or equal to 100 and less than or equal to 8,000.

17. The water electrolysis device of claim 14, wherein the one or more hydrophilic domains comprise a proton conductive repeating portion represented by Formula 1,
wherein the Formula 1 corresponds to: 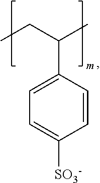
and
wherein m is an integer that is greater than or equal to 100 and less than or equal to 8,000.

18. The water electrolysis device of claim 14, wherein the one or more hydrophobic domains comprise a hard segment and an antioxidative segment.

19. The water electrolysis device of claim 18, wherein the hard segment comprises at least one of repeating portions represented by Formula 2-1, Formula 2-2, and Formula 2-3,
wherein Formula 2-1 corresponds to: 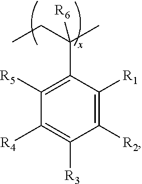
wherein each of R₁ to R₅ of the Formula 2-1 comprises a hydrogen, an alkyl group having 1 to 12 carbon atoms, a tert-butyl group, a phenyl group, 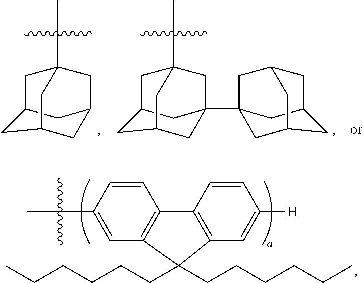
wherein a corresponds to 1, 2, or 3, R₆ comprises hydrogen or an alkyl group having 1 to 12 carbon atoms, and x of the Formula 2-1 corresponds to a number greater than 0 and less than or equal to 0.9,
wherein the Formula 2-2 corresponds to: 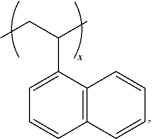
wherein x of the Formula 2 corresponds to a number greater than 0 and less than or equal to 0.9,
wherein the Formula 2-3 corresponds to: 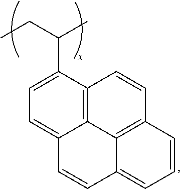
and
wherein x of the Formula 2-3 corresponds to a number greater than 0 and less than or equal to 0.9.

20. The water electrolysis device of claim 19, wherein the antioxidative segment comprises one or more nitric oxide (NO) radicals.
